(19) United States
(12) Patent Application Publication
(10) Pub. No.: US 2012/0301109 A1
(43) Pub. Date: Nov. 29, 2012

(54) VIDEO-SOUND FILE UPDATE SYSTEM AND VIDEO-SOUND FILE UPDATE METHOD

(75) Inventor: Hajime KOBAYASHI, Tokyo (JP)

(73) Assignee: NEC CORPORATION, Tokyo (JP)

(21) Appl. No.: 13/479,500

(22) Filed: May 24, 2012

(30) Foreign Application Priority Data
May 27, 2011 (JP) 2011-118888

(51) Int. Cl. H04N 5/92

(52) U.S. Cl. 386/244; 386/E05.009

(57) ABSTRACT

A video server selects video-sound data that requires an update of subtitle data from a video-sound file directly transmitted from a video storage apparatus, and transmits the selected video-sound data to a subtitle superimposition control apparatus. When a time code in a data block of the video-sound data matches with the time code assigned to replacement subtitle data, the subtitle superimposition control apparatus superimposes the replacement subtitle data onto the video-sound data and transmits the replaced data to the video server.

### CROSS REFERENCE TO RELATED APPLICATIONS

Priority is claimed on Japanese Patent Application No. 2011-118888, filed May 27, 2011, the content of which is incorporated herein by reference.

### BACKGROUND OF THE INVENTION

1. Field of the Invention

The present invention relates to a video-sound file update system and a video-sound file update method and, in particular, to a video-sound file update system and a video-sound file update method which make it possible to update only the superimposed subtitle data without playing source data when an update process of the subtitle data is required after the source data has been filed.

2. Description of Related Art

In recent years, as the processing ability of information processing apparatuses improves, video-sound files that record video-sound increase more than the code information.

The data of the video-sound files are required to be updated or modified. In update processes, although some cases require updating the entire data of the video-sound files, many other cases require updating only subtitle data that is attached to images.

In general, with respect to video-sound files, it was impossible to update recorded subtitle data without re-filling by replaying the video-sound files. It is difficult to update the subtitle data without replaying the video-sound files. Accordingly, when subtitle data need to be updated, a re-filling process has to be performed.

After original source data (an original data prior to being updated) has been filed, the filed original source data are output (replayed) while being monitored with a monitoring display apparatus or the like. In this step, if corrections are necessary for subtitle data, a refilling process is performed by use of substitute subtitle data.

However, the time required for re-filling subtitle data simply becomes is double of that required for recording the original source data of video-sound data. Thus, a large number of man-hours have been required for file-administrators to maintain video-sound files and for system operators and managers to operate the video-sound file operation-management systems.

In recent years, with respect to video apparatuses which record and play video-sound data, a function that enables it to directly transmit recorded video-sound data without playing the recorded video-sound data has been developed for improving copying performance.

FIG. 3 is a block diagram that illustrates the configuration of a conventional video-sound file update system.

The conventional video-sound file update system shown in FIG. 3 includes a video storage apparatus 91 that records and plays video-sound files, a video-server 92 that reads and transmits the replayed video-sound files to another apparatus, a subtitle data superimposition control apparatus 93 that manages to superimpose subtitle data onto the video-sound data of video-sound file, a subtitle data storage apparatus 94 that stores subtitle data, and a subtitle inserter 95 that inserts subtitle data into video-sound data. The subtitle data storage apparatus 94 may be any storage device capable of storing digital data, such as a disk drive, a flash memory drive, an optical drive (e.g., CD-ROM), a floppy disk, or the like.

Operations of the video-sound file update system shown in FIG. 3 will be described below.

The subtitle data storage apparatus 94 stores subtitle data which are replacement subtitle data to be superimposed and remained on video-sound data after updating.

Data blocks forming the replacement subtitle data are provided with time codes which correspond to the video-sound data to which the replacement subtitle data are superimposed.

A time code is a code which is uniquely provided for each single frame (a single block) of the video-sound data and used for uniquely identifying a single frame of the video-sound data.

The replacement subtitle data is read out beforehand from the subtitle data storage apparatus 94 and transmitted to the subtitle data superimposition control apparatus 93.

In the following, descriptions will be given with respect to updating subtitles of the video-sound data included in the video-sound file stored in the video storage apparatus 91 or initially adding subtitles to the video-sound data included in the video-sound file.

The video storage apparatus 91 is switched on first, and a video-sound file that includes video-sound data to be updated is played with the video storage apparatus 91.

Thereby, the video-sound data output from the video storage apparatus 91 are transmitted to the subtitle inserter 95. Simultaneously, the video storage apparatus 91 transmitted time codes corresponding to the video-sound data to the subtitle data superimposition control apparatus 93.

The subtitle data superimposition control apparatus 93 receives time codes sequentially transmitted from the video storage apparatus 91, and successively determines if the time codes to be received match with time codes given for the replacement subtitle data obtained from the subtitle data storage apparatus 94.

When the subtitle data superimposition control apparatus 93 receives a time code that matches with a time code given for the replacement subtitle data, the subtitle data superimposition control apparatus 93 transmits the replacement subtitle data corresponding to the matched time code to the subtitle inserter 95.

When the subtitle inserter 95 receives the replacement subtitle data from the subtitle data superimposition control apparatus 93, the subtitle inserter 95 inserts the replacement subtitle data onto the video-sound data transmitted at that received time from the video storage apparatus 91.

After updating the subtitle of the video-sound data, the video-sound data file is transmitted from the subtitle inserter 95 to the video server 92.

As related art in this field, for example, Japanese Unexamined Patent Application, First Publication No. 2008-236257 (patent document 1) describes a video server apparatus that is capable of replacing video data with non-video data. Specifically, the video server apparatus separately records video data, sound data, subtitle data, and additional data so that the video server apparatus can play any combination of those data. That is, while recording, the video server apparatus records video data, sound data, and additional data (subtitle data, ancillary data or the like) respectively as single source data. While playing, the video server apparatus combines this source data and plays the combined data. In this manner, it is possible to respond to the requirements that parts of the source data are replaced with another source data. In other words, it is possible to replace only voice data or only subtitle information after recording video.

Further, Japanese Unexamined Patent Application, First Publication No. 2009-055398 (patent document 2) describes a program bank system that includes an automatic subtitle comparison function which is capable of automatically determining if the content of superimposed subtitle data included in video-sound source data recorded on a video server is correct without being examined by an operator watching the entire video-sound source data. In the program bank system, subtitle data is recorded on the video server by being superimposed in ancillary packet regions of digital video signals of video data from a video-sound player using an ANC inserter. The subtitle data is extracted from the video data played with the video server using an ANC reader, in which the video data includes the superimposed subtitle data. A control computer of the program bank system compares the contents of former subtitle data that are not superimposed with the ANC inserter and the subtitle data extracted with the ANC reader. The program bank system determines if the contents of the superimposed subtitle data are correct. If the comparison of those contents do not match each other, then the program bank system indicates an error.

However, the systems described in patent documents 1 and 2 require directly editing data stored on a server when subtitle data need to be re-edited, so these are not preferable systems from the point of view of data-handling or usability for editors.

### SUMMARY OF THE INVENTION

In consideration of the problem described above, an exemplary aspect of the present invention is to provide a video-sound file update system, includes a video-sound data storage unit configured to perform data transmission without playing playable video-sound data, a video server unit configured to record video-sound data transmitted from the video-sound data storage unit, select the video-sound data that are required to be updated from the recorded video-sound data, and transmit the video-sound data selected by the video server unit, and a subtitle data superimposition unit configured, with respect to time codes assigned to respective single frames of the video-sound data transmitted from the video server unit being matched with predetermined time codes of predetermined replacement subtitle data, to replace original subtitle data by superimposing the predetermined replacement subtitle data that the predetermined time codes match with the time codes on the original subtitle data and, after replacing the subtitle data, to transmit the entire video-sound data to the video server unit.

In accordance with an exemplary aspect of the present invention, a video-sound file update system, includes a video-sound data storage unit configured to perform data transmission without playing playable video-sound data, a video server unit configured to record video-sound data transmitted from the video-sound data storage unit, and a subtitle data superimposition unit configured to request the video-sound data storage unit to transmit a video-sound fail required to be updated or video-sound data required to be updated, with respect to time codes respectively assigned to single frames of the video-sound data transmitted from the video server unit being matched with predetermined time codes of predetermined replacement subtitle data, to replace original subtitle data by superimposing the predetermined replacement subtitle data that the predetermined time codes match with the time codes on the original subtitle data and after replacing the subtitle data, and to transmit the entire video-sound data to the video server unit.

In accordance with an exemplary aspect of the present invention, a video-sound file update system includes a video-sound data storage unit configured to perform data transmission without playing playable video-sound data, a video server unit configured to record video-sound data transmitted from the video-sound data storage unit, and a subtitle data superimposition unit configured to request the video-sound data storage unit to transmit a video-sound fail required to be updated or video-sound data required to be updated, with respect to time codes respectively assigned to single frames of the video-sound data transmitted from the video server unit being matched with predetermined time codes of predetermined replacement subtitle data, to replace original subtitle data by superimposing the predetermined replacement subtitle data that the predetermined time codes match with the time codes on the original subtitle data and after replacing of the subtitle data, and to transmit the entire video-sound data to the video server unit.

### BRIEF DESCRIPTION OF THE DRAWINGS

FIG. 1 is a block diagram that illustrates a video sound file update system in accordance with an embodiment of the present invention;

FIG. 2 is a drawing that illustrates a data structure of a single frame (a single block) of a video-sound file; and

FIG. 3 is a drawing that illustrates a block structure of a conventional video-sound file update system.

### DETAILED DESCRIPTION OF THE INVENTION

A video-sound file update system in accordance with the present invention directly transmits (or performs direct data transmission to a video storage apparatus) data using its communication function without playing video-sound data frame by frame with a video storage apparatus that stores and plays the video-sound data.

In this way, the time required for updating subtitles of the video-sound data is shortened by omitting the time required for playing the video-sound data, so that a subtitle update process is simplified and speed up.

Descriptions will be given in detail below for a video-sound file update system and a video-sound file update method in accordance with an embodiment of the present invention, with reference to drawings.

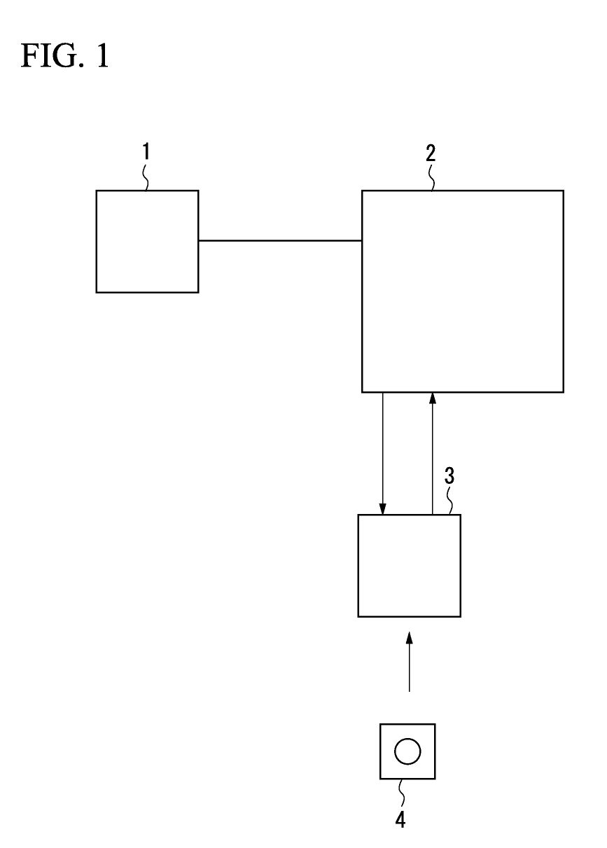

FIG. 1 is a block diagram that illustrates a video-sound file update system in accordance with an embodiment of the present invention.

The video-sound file update system shown in FIG. 1 includes a video storage apparatus 1 (or video-sound data storage unit) that records and plays video-sound data, a video server 2 (or video server unit) that receives video-sound files via data-transmission and provides the data to another apparatus, a subtitle data superimposition control apparatus 3 (or subtitle data superimposition unit) that manages to superimpose subtitle data onto the video-sound data of a video-sound file, and a subtitle data storage apparatus 4 that stores subtitle data. For example, the subtitle data superimposition control apparatus 3 receives ANC data from the video server 2. The subtitle data storage apparatus 4 may be any storage device capable of storing digital data, such as a disk drive, a flash memory drive, an optical drive (e.g., CD-ROM), a floppy disk, or the like.

In this case, it is assumed that the video-sound data of a video-sound file can be superimposed with subtitle data. The subtitle data may be, for example, ANC (Ancillary) subtitle data that are stored in an ANC region of video-sound data.

Further, each element described above including the video storage apparatus 1 is assumed to have a communication function that can directly transmit video-sound data.

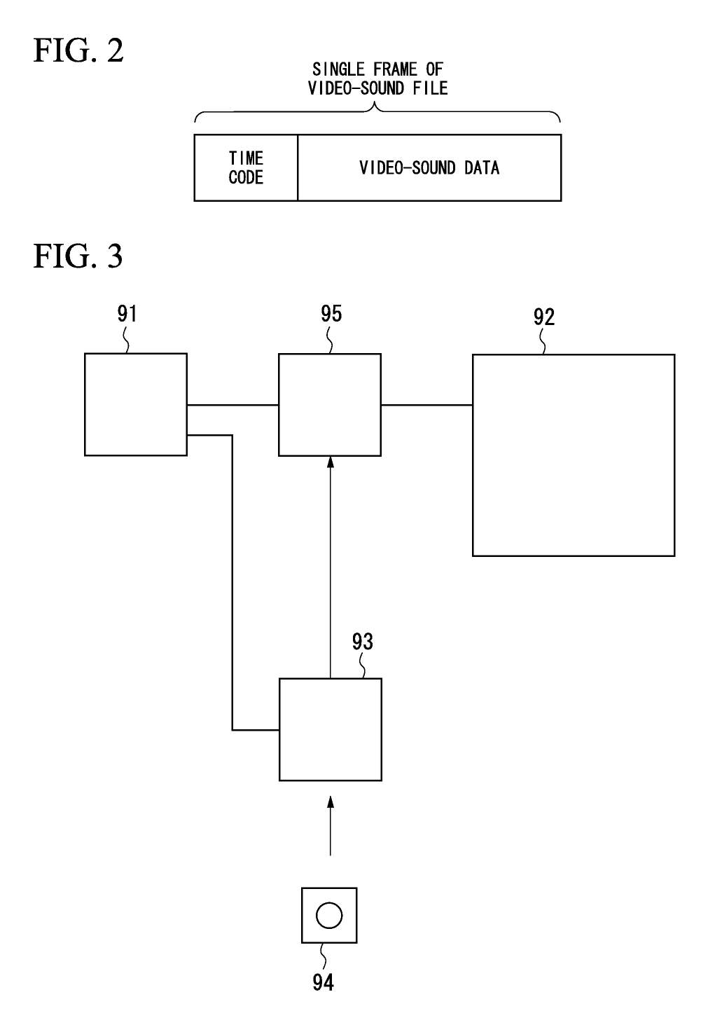

FIG. 2 is a drawing that illustrates a data structure of a single frame (a single block) of a video-sound file.

Data of a single frame of a video-sound file includes video-sound data and a time code that uniquely indentifies the video-sound data of a single frame as shown in FIG. 2.

A process that inserts predetermined subtitle data into video data of the video-sound data corresponds to a process that superimposes the predetermined subtitle data onto the video-sound data (see FIG. 2).

The operations of the video-sound file update system in FIG. 1 will be described below with reference to FIG. 2.

The subtitle data storage apparatus 4 stores subtitle data for replacement (replacement subtitle data) which the subtitle data remain after updating by being superimposed onto the video-sound data.

The data block forming the replacement subtitle data is provided with a time code corresponding to the video-sound data on which the replacement subtitle data is superimposed.

In general, the time code is provided while video-sound data is being recorded, and assigned to each single frame (single block) of the video-sound data. The assigned code can be used to uniquely identify a single frame of the vide-sound data (see FIG. 2).

The replacement subtitle data are preliminarily read from the subtitle data storage apparatus 4 and transmitted to the subtitle data superimposition control apparatus 3.

It is described below how to update subtitles of the video-sound data in video-sound file stored in the video storage apparatus 1, or how to initially assign subtitles to the video-sound data in a video-sound file.

In the first step, the video-sound data stored in the video storage apparatus 1 or the filed entire video-sound data transmission is performed from the video storage apparatus 1 to the video server 2.

In this case, the data transmission is direct transmission that is performed without playing the video-sound data using the communication function described above.

As shown in FIG. 2, each data block of the video-sound file is assigned a time code that is uniquely matched to a single frame of the video-sound data. Further, the video-sound data of some data brocks are superimposed with subtitles that have not been updated.

The video server 2 stores the video-sound file transmitted from the video-storage apparatus 1 into the built-in database (not shown in the figure) of the video server 2, selects the entire video-sound file that needs to be updated or more than a single video-sound data of the video-sound file that needs to be updated to the subtitle data superimposition control apparatus 3, and transmits that data.

If a time code that is included in a data block among the video-sound data received from the video server 2 corresponds to the time code assigned to the replacement subtitle data, then the subtitle data superimposition control apparatus 3 superimposes the replacement subtitle data on the video-sound data.

In this case, the replacement subtitle data that have been used for replacement can be attached with a flag indicating “updated.” Otherwise, the updated day and time can be recorded instead.

Further, such information (the flag indicating “updated” or the updated date and time) can be used for managing the replacement subtitle data and the state of progress of a subtitle update process using a video-sound file update system.

After a subtitle update process has been completed for the entire frames of the video-sound data with respect to the video-sound file received from the video server 2, the subtitle data superimposition control apparatus 3 performs data transmission of the updated video-sound data to the video server 2.

In the last step, the video server 2 replaces the updated video-sound data received from the subtitle data superimposition control apparatus 3 with the original video-sound data.

In accordance with the video-sound file update system of the present embodiment, it is effective for the operators and administrators of system operations who can simply and quickly update subtitle signals of a video-sound file output from the video storage apparatus 1 with it as a video-sound file update system including a subtitle superimposition system even after the video-sound file has been recorded.

More specifically, even if a video-sound file including the content of subtitles in improper condition is recorded in the video server 1, the video-sound file update system can properly update the subtitles in improper condition as the final subtitles without playing the entire video-sound file.

In other words, the processing time required to update the subtitles is determined only by the transmission time of data, so that the processing time can be shortened enough compared to that required in a conventional method that needs to play the entire video-sound file.

Furthermore, operation procedures are simple and repeatable for performing the update processing, and this enables it to easily update subtitle signals that have been once determined as many times as required before the subtitle signals are transmitted.

### Other Embodiments

In the above, the previous embodiment was described such that specific video-sound data are transmitted from the video storage apparatus 1 to the video server 2, or that the data transmission is performed for the entire video-sound data filed in a file. As another embodiment, the video server 2 may request the video storage apparatus 1 for transmitting specific video-sound data, or for transmitting the entire video-sound data filed in a file, so that the video server 2 can receive only the requested data. The subsequent procedures are the same as those described in the previous embodiment.

Furthermore, as another embodiment, the subtitle data superimposition control apparatus 3 may requests the video server 2 for transmitting the video-sound data that requires updating the subtitle data, or for transmitting the entire video-sound data filed in a file that requires updating the subtitle data, so that the subtitle data superimposition control apparatus 3 can receive the only requested data. The subsequent procedures are the same as those described in the previous embodiment.

Further, as another embodiment, the subtitle data superimposition control apparatus 3 may directly request the video storage apparatus 1 without using the video server 2 for transmitting the video-sound data that requires updating the subtitle data, or for transmitting the entire video-sound data filed in a file that requires updating the subtitle data, so that the subtitle data superimposition control apparatus 3 can receive the only requested data. The subsequent procedures are the same as those described in the previous embodiment.

Furthermore, as another embodiment, the subtitle data superimposition control apparatus 3 can transmit the video-sound data of a single frame to the video server 2 every time the subtitle update process of the single frame with respect to the video-sound data received from the video server 2 is completed. Such a process is continued until the update process is completed for the given entire data blocks. The subsequent procedures are the same as those described in the previous embodiment.

According to the embodiments of the present invention, as a video-sound file update system enables data to be directly transmitted without playing video-sound data with a video-sound storage apparatus, operators or administrators of the system can easily and quickly update subtitle signals of the video-sound file transmitted from a video storage apparatus even after the video-sound file has been recorded.

Furthermore, when source data need to be updated after the source data have been filed in a video storage apparatus, a video-sound update system in accordance with the present invention picks out the source data directly from the video storage apparatus based on direct data transmission without playing and performs a subtitle update process, so that it is possible to simply and quickly update the source data.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A video-sound file update system, comprising:
a video-sound data storage unit configured to perform data transmission without playing playable video-sound data;
a video server unit configured to record video-sound data transmitted from the video-sound data storage unit, select the video-sound data that are required to be updated from the recorded video-sound data, and transmit the video-sound data selected by the video server unit; and
a subtitle data superimposition unit configured, with respect to time codes assigned to respective single frames of the video-sound data transmitted from the video server unit being matched with predetermined time codes of predetermined replacement subtitle data, to replace original subtitle data by superimposing the predetermined replacement subtitle data that the predetermined time codes match with the time codes on the original subtitle data and, after replacing of the subtitle data, transmit the entire video-sound data to the video server unit.

2. The video-sound file update system as claimed in claim 1, wherein
the video-sound data is filed in a file,
the video-sound data transmitted from the video server unit to the subtitle data superimposition unit is an entire video-sound data included in one or more than one files, or is part of video-sound data included in a file.

3. The video-sound file update system as claimed in claim 1, wherein
the video server unit requests the video-sound data storage unit to transmit the entire video-sound data or only predetermined video-sound data.

4. The video-sound file update system as claimed in claim 2, wherein
the subtitle data superimposition unit requests the video server unit to transmit the entire video-sound data that the subtitle data need to be updated or one or more than one frames of video-sound data required to be updated in a video-sound file required to be updated so that only the video-sound data required to be updated are received and updated by replacing the subtitle data.

5. The video-sound file update system as claimed in claim 2, wherein
the video subtitle data superimposition unit transmits, at every time when a subtitle update process has completed for one frame of the video-sound data received from the video server unit, the one frame of the video-sound data to the video server unit.

6. A video-sound file update system, comprising:
a video-sound data storage unit configured to perform data transmission without playing playable video-sound data;
a video server unit configured to record video-sound data transmitted from the video-sound data storage unit; and
a subtitle data superimposition unit configured to request the video-sound data storage unit to transmit a video-sound fail required to be updated or video-sound data required to be updated, with respect to time codes respectively assigned to single frames of the video-sound data transmitted from the video server unit being matched with predetermined time codes of predetermined replacement subtitle data, to replace original subtitle data by superimposing the predetermined replacement subtitle data that the predetermined time codes match with the time codes on the original subtitle data and after replacing of the subtitle data, and to transmit the entire video-sound data to the video server unit.

7. The video-sound file update system as claimed in claim 6, wherein
the video-sound data is filed in a file,
the video-sound data transmitted from the video-sound data storage unit to the subtitle data superimposition unit is an entire video-sound data included in one or more than one files, or is part of video-sound data included in a file.

8. The video-sound file update system as claimed in claim 6, wherein
every time when a subtitle update process is completed for a single frame of the video-sound data received from the video-sound data storage unit, the subtitle data superimposition unit transmits the video-sound data of the single frame.

9. A video-sound file update method, comprising:
a video-sound data storage step performing data transmission in without playing playable video-sound data;
a video-sound data storage step recording video-sound data transmitted in the video-sound data storage step, selecting the video-sound data that are required to be updated from the recorded video-sound data, and transmitting the video-sound data selected in the video server step; and
a subtitle data superimposition step replacing, with respect to time codes assigned to respective single frames of the video-sound data transmitted in the video server step being matched with predetermined time codes of predetermined replacement subtitle data, original subtitle data by superimposing the predetermined replacement subtitle data that the predetermined time codes match with the time codes on the original subtitle data and, after replacing of the subtitle data, transmitting the entire video-sound data to the video server step.

10. The video-sound file update method as claimed in claim 9, wherein
the video-sound file is filed as a file, and the video-sound data transmitted in the subtitle data superimposition step from the video-sound data storage step is an entire video-sound data included in one or more than one files, or is part of video-sound data included in a file.
